(19) United States
(12) Patent Application Publication
(10) Pub. No.: US 2019/0177605 A1
(43) Pub. Date: Jun. 13, 2019

(54) MULTIFUNCTIONAL SINGLE COMPONENT SYSTEMS AND METHODS FOR SANDSTONE ACIDIZING

(71) Applicant: HALLIBURTON ENERGY SERVICES, INC., HOUSTON, TX (US)

(72) Inventors: Sairam Eluru, Pune (IN); Vijaya Kumar Patnana, Madurwada (IN)

(21) Appl. No.: 16/324,036

(22) PCT Filed: Oct. 3, 2016
(86) PCT No.: PCT/US2016/055160

§ 371 Date: Feb. 7, 2019

(51) Int. Cl. C09K 8/74; C09K 8/528

(52) U.S. Cl. CPC C09K 8/74; C09K 8/528

(57) ABSTRACT

Methods and compositions for treating a sandstone formation are provided. The methods include providing a treatment fluid and introducing the treatment fluid into at least a portion of the sandstone formation. The treatment fluid includes an acidic base fluid and fulvic acid, any salt thereof, any derivative thereof or any combination thereof. The fulvic acid, any salt thereof, any derivative thereof, or any combination thereof, inhibits formation of silica scale in the sandstone formation.

### BACKGROUND

The present invention relates generally to treating sandstone formations. In particular, the present invention relates to methods of treating a sandstone formation by providing a treatment fluid including fulvic acid, any salt thereof, or any derivative thereof, or any combination thereof, and introducing the treatment fluid into the sandstone formation.

Treatment fluids including an acidic base fluid can be used in a number of subterranean operations including, for example, stimulation acidizing treatments/operations. Treatments utilizing an acidic base fluid are especially challenging in some subterranean formations due to siliceous and aluminosilicate minerals commonly encountered therein. These silicon containing minerals can interact with an acidic base fluid to produce dissolved silicon species, which can subsequently precipitate at higher pH values (e.g., greater than about 3) as amorphous, gelatinous and/or colloidal silica.

By far the most common method of treating sandstone and other siliceous formations involves introducing corrosive, very low pH acids including hydrofluoric acid (HF) into the wellbore and allowing the acid to react with the formation matrix. In contrast to other mineral acids, HF is very reactive with aluminosilicates and silicates (e.g., quartz, clays and feldspars). Hydrochloric acid (HCl) may be used in addition to HF in the treatment fluid to maintain a low pH as HF is spent during a treatment operation, thereby retaining certain dissolved species in a highly acidic solution.

HF can interact with the formation matrix, base fluids, or formation fluids to create precipitates, particularly in the presence of metal ions such as Al³⁺, Group 1 metal ions (e.g., Na⁺ and K⁺) and/or Group 2 metal ions (e.g., Mg²⁺, Ca²⁺, and Ba²⁺), thereby leading to damage. For instance, precipitation of various aluminum and silicon complexes can occur as a result of the reaction of the acid with the siliceous materials. Damage to the formation can result from the precipitation.

The reaction of HF with a sandstone formation occurs in three stages. In the first stage, clay in the formation reacts with HF to form fluorosilicic acid and aluminum fluoride. In the second stage, silica gel is formed, and in the third stage, aluminum fluoride is formed. These materials, in each case, form precipitates that are detrimental to the formation and must be cleared to prevent damage.

Chelating agents are materials that are employed, among other uses, to control undesirable reactions of metal ions. In oilfield chemical treatments, chelating agents are frequently added to matrix stimulation acids to prevent precipitation of solids as the acids react with the formation being treated. While typical chelating agents are capable of complexing metal ions, they often fail to complex silica, resulting in the precipitation of silica gel. These gel precipitates create damage to the formation, and are very difficult to remove from the formation. Thus, there is a continuing need for improved treatment fluids and methods for treating sandstone formations.

### BRIEF DESCRIPTION OF THE DRAWINGS

The following figures are included to illustrate certain aspects of the present invention, and should not be viewed as an exclusive embodiment. The subject matter disclosed is capable of considerable modification, alteration, and equivalents in form and function, as will occur to those of ordinary skill in the art and having the benefit of this disclosure.

FIG. 1 illustrates a land-based drilling and production system; and

FIG. 2 depicts a method of treating a sandstone formation according to embodiments of the present invention.

### DETAILED DESCRIPTION

According to several exemplary embodiments, the methods of the present invention inhibit the formation of silica scale in a sandstone formation using the chelating agent fulvic acid, any salt thereof, or any derivative thereof, or any combination thereof. As used herein, the term “silica scale” refers to precipitated amorphous silica, precipitated gelatinous silica, precipitated colloidal silica, and/or hardened crusts of amorphous silica, precipitated silica, and/or precipitated colloidal silica.

Advantageously, fulvic acid acts as a single component system that can chelate several metal ions encountered in sandstone formations, including Al³⁺, Ca²⁺, and Mg²⁺, while also inhibiting precipitation of silica and/or silica scale. Without being bound by theory, it is believed that the fulvic acid slows, prevents, or inhibits silica polymerization and/or forms a soluble complex with silica to avoid silica gel formation. The presence of several hydroxyl and carboxyl groups in fulvic acid make it very unique and helps in chelating different bivalent and trivalent ions, along with inhibiting the formation of silica scale.

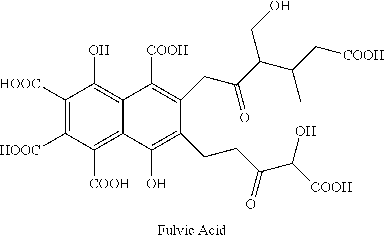 [SMILES: CC(CC(=O)O)C(CO)C(=O)Cc1c(CCC(=O)C(O)C(=O)O)c(O)c2c(C(=O)O)c(C(=O)O)c(C(=O)O)c(O)c2c1C(=O)O]

According to several exemplary embodiments, a method of treating a sandstone formation is provided. The method includes providing a treatment fluid including an acidic base fluid and fulvic acid, any salt thereof, any derivative thereof, or any combination thereof, and introducing the treatment fluid into at least a portion of the sandstone formation. The fulvic acid, any salt thereof, any derivative thereof, or any combination thereof, inhibits formation of silica scale in the sandstone formation. As used herein, a “sandstone formation” refers to a formation composed of about 40% to about 98% sand/quartz particles, i.e., silica (SiO₂), bonded together by various amounts of cementing material including carbonate (calcite or CaCO₃, dolomite, ankerite, siderite etc), aluminosilicates (xlays, feldspars, etc.), and silicates.

According to several exemplary embodiments, the acidic base fluid includes an aqueous-based fluid. According to several exemplary embodiments, the acidic base fluid includes one or more acids selected from the group consisting of hydrofluoric acid, hydrochloric acid, acetic acid, formic acid, citric acid, boric acid, lactic acid, methyl sulfonic acid, ethyl sulfonic acid, oxalic acid, malic acid, and maleic acid. According to several exemplary embodiments, the one or more acids is present in the treatment fluid in an amount of about 0.01 percent to about 30 percent by volume of the treatment fluid.

According to several exemplary embodiments, the fulvic acid, any salt thereof, any derivative thereof, or any combination thereof, is present in the treatment fluid in an amount of about 1 percent to about 20 percent by weight of the treatment fluid.

According to several exemplary embodiments, the method further includes complexing at least a portion of any metal ions present in the sandstone formation with the fulvic acid, any salt thereof, any derivative thereof, or any combination thereof. Suitable metal ions include one or more of aluminum, calcium, and magnesium.

According to several exemplary embodiments, the treatment fluid has a pH of about 1 to about 3. According to several exemplary embodiments, a pump is used to introduce the treatment fluid into at least a portion of the sandstone formation. According to several exemplary embodiments, the method further includes after introducing the treatment fluid, allowing the treatment fluid to reside in the sandstone formation for a period of time, and removing the treatment fluid from the sandstone formation.

According to several exemplary embodiments, another method of treating a sandstone formation is provided. The method includes providing a treatment fluid including an aqueous fluid, hydrofluoric acid, hydrochloric acid, and fulvic acid, any salt thereof, any derivative thereof, or any combination thereof, and introducing the treatment fluid into at least a portion of the sandstone formation, wherein the fulvic acid, any salt thereof, any derivative thereof, or any combination thereof, inhibits formation of silica scale in the sandstone formation.

According to several exemplary embodiments, the hydrofluoric acid and hydrochloric acid is present in the treatment fluid in an amount of about 0.01 percent to about 30 percent by volume of the treatment fluid. According to several exemplary embodiments, the fulvic acid, any salt thereof, any derivative thereof, or any combination thereof, is present in the treatment fluid in an amount of about 0.01 percent to about 20 percent by weight of the treatment fluid.

According to several exemplary embodiments, the method further includes complexing at least a portion of any metal ions present in the sandstone formation with the fulvic acid, any salt thereof, any derivative thereof, or any combination thereof. Suitable metal ions include one or more of aluminum, calcium, and magnesium.

According to several exemplary embodiments, the method further includes after introducing the treatment fluid, allowing the treatment fluid to reside in the sandstone formation for a period of time, and removing the treatment fluid from the sandstone formation.

According to several exemplary embodiments, a treatment fluid for acidizing a sandstone formation is provided. The treatment fluid includes an aqueous fluid, hydrofluoric acid, hydrochloric acid, and fulvic acid, any salt thereof, any derivative thereof, or any combination thereof in an amount sufficient to inhibit formation of silica scale in the sandstone formation.

According to several exemplary embodiments, the treatment fluid has a pH of about 1 to about 3. According to several exemplary embodiments, the hydrofluoric acid and hydrochloric acid is present in the treatment fluid in an amount of about 0.01 percent to about 30 percent by volume of the treatment fluid. According to several exemplary embodiments, the fulvic acid, any salt thereof, any derivative thereof, or any combination thereof, is present in the treatment fluid in an amount of about 0.01 percent to about 20 percent by weight of the treatment fluid.

As used herein, “treat,” “treatment,” and “treating” refer to any subterranean operation that uses a fluid in conjunction with achieving a desired function and/or for a desired purpose. More specific examples of treatment operations include drilling operations, fracturing operations, gravel packing operations, acidizing operations, scale dissolution and removal, sand control operations, and consolidation operations.

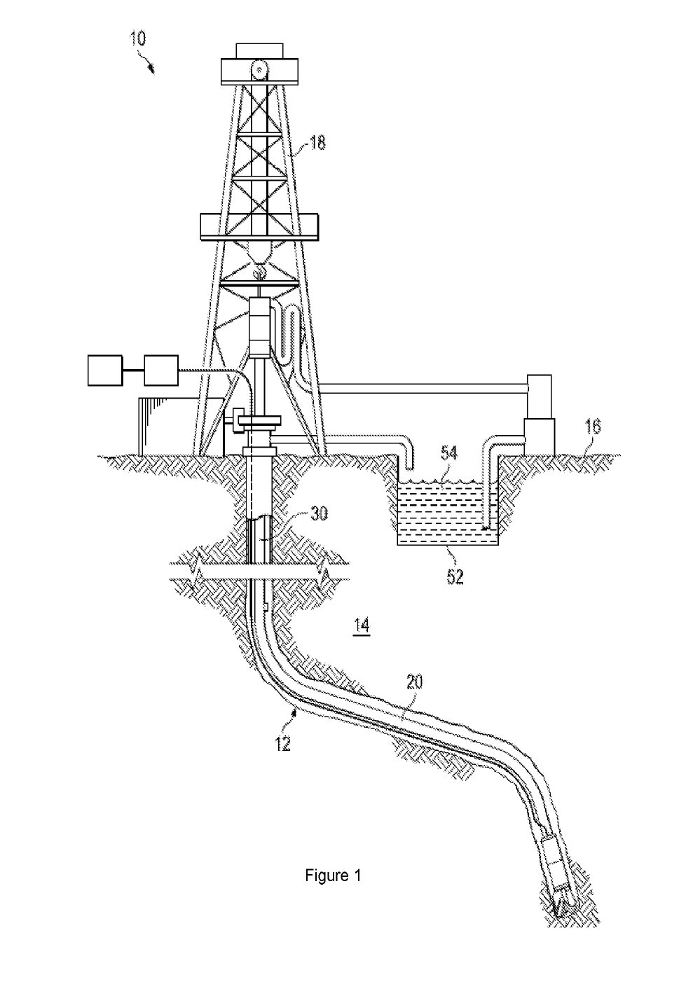

Turning to FIG. 1, shown is an elevation view in partial cross-section of a wellbore drilling and production system 10 utilized to produce hydrocarbons from wellbore 12 extending through various earth strata in an oil and gas formation 14 located below the earth's surface 16. Drilling and production system 10 may include a drilling rig or derrick 18 to perform various activities related to drilling or production, such as the methods described below. Likewise, drilling and production system 10 may include various types of tools or equipment 20 supported by rig 18 and disposed in wellbore 12 for performing these activities.

A working or service fluid source 52, such as a storage tank or vessel, may supply a working fluid 54 that is pumped to the upper end of tubing string 30 and flows through tubing string 30. Working fluid source 52 may supply any fluid utilized in wellbore operations, including without limitation, drilling fluid, slurry, acidizing fluid (e.g., HF, HCl, acetic acid, etc.), liquid water, steam, hydraulic fracturing fluid, propane, nitrogen, carbon dioxide or some other type of fluid.

According to several exemplary embodiments, a method of treating a sandstone formation includes using fulvic acid in a treatment fluid. Advantageously, fulvic acid is an efficient and affordable chelating material that has good thermal stability and is produced from organic compost material. In addition, fulvic acid is soluble in water in all pH conditions and can be used at any starting pH for treatments of sandstone formations.

According to several exemplary embodiments, due to its operable pH range, fulvic acid is suitable for use in acid-sensitive subterranean formations in which strong acid treatment fluids cannot be effectively used for inhibiting or removing silica scale deposition. For example, sandstone formations are particularly sensitive to acids at high temperature and are often not amenable to acidizing treatments due to their propensity to deconsolidate and lose cementing material in the presence of strong acids. Further, sandstone formations are very prone to formation of silica scale due to their chemical makeup. In sandstone formations, the presence of fulvic acid advantageously offers a much wider pH window for conducting subterranean operations. Furthermore, the methods of the present invention complement the use of existing, strongly acidic treatment fluids by maintaining high levels of dissolved silicon in a treatment fluid that are otherwise only attainable at much lower pH values.

According to several exemplary embodiments, the use of fulvic acid is further advantageous because it can effectively coordinate with metal ions (e.g., Al³⁺) even in the presence of dissolved silicon. At pH values of 3 or above, Al³⁺ and soluble silicon species react to form insoluble aluminosilicate materials, thereby exacerbating an already challenging precipitation problem. As used herein, the term “dissolved silicon” refers to silicic acid, silanols, and other soluble silicon species. According to several exemplary embodiments, certain metal ions are capable of reacting or complexing with fulvic acid, thereby potentially rendering them unsuitable for associating with dissolved silicon.

According to several exemplary embodiments, fulvic acid may be used in combination with one or more other chelating agents for the treatment of a sandstone formation. Suitable chelating agents include methylglycine diacetic acid (MGDA), glutamic acid diacetic acid (GLDA), β-alanine diacetic acid, ethylenediaminedisuccinic acid, S,S-ethylenediaminedisuccinic acid, iminodisuccinic acid, hydroxyiminodisuccinic acid, polyamino disuccinic acids, N-bis[2-(1,2-dicarboxyethoxy)ethyl]glycine, N-bis[2-(1,2-dicarboxyethoxy)ethyl]aspartic acid, N-bis[2-(1,2-dicarboxyethoxy)ethyl]methylglycine, N-tris[(1,2-dicarboxyethoxy)ethyl]amine, N-methyliminodiacetic acid, iminodiacetic acid, N-(2-acetamido)iminodiacetic acid, hydroxymethyl-iminodiacetic acid, 2-(2-carboxyethylamino)succinic acid, 2-(2-carboxymethylamino)succinic acid, diethylenetriamine-N,N″-disuccinic acid, triethylenetetramine-N,N′″-disuccinic acid, 1,6-hexamethylenediamine-N,N′-disuccinic acid, tetraethylenepentamine-N,N″″-disuccinic acid, 2-hydroxypropylene-1,3-diamine-N,N′-disuccinic acid, 1,2-propylenediamine-N,N′-disuccinic acid, 1,3-propylenediamine-N,N′-disuccinic acid, cis-cyclohexanediamine-N,N′-disuccinic acid, trans-cyclohexanediamine-N,N′-disuccinic acid, ethylenebis(oxyethylenenitrilo)-N,N′-disuccinic acid, glucoheptanoic acid, cysteic acid-N,N-diacetic acid, cysteic acid-N-monoacetic acid, alanine-N-monoacetic acid, N-(3-hydroxysuccinyl)aspartic acid, N-[2-(3-hydroxysuccinyl)]-L-serine, and aspartic acid-N,N-diacetic acid, aspartic acid-N-monoacetic acid.

According to several exemplary embodiments, the treatment fluids include an acidic base fluid and fulvic acid, any salt thereof, or any derivative thereof, or any combination thereof. According to several exemplary embodiments, the acidic base fluid includes HF and an additional acid, such as HCl or a weaker acid (e.g., acetic acid) to slow down the release rate of hydrogen ion to retard the HF reaction and to provide deep penetration in the sandstone formation.

According to several exemplary embodiments, the acidic base fluid is an aqueous-based fluid. Aqueous-based fluids that are suitable include, for example, fresh water, saltwater (e.g., water containing one or more salts dissolved therein), brine, seawater, or combinations thereof. Generally, the water can be from any source, provided that it does not contain significant quantities of materials that might adversely affect the stability and/or performance of the treatment fluid. In particular, the aqueous-based fluids ideally should not contain significant quantities of metal ions that are reactive with fulvic acid or form an insoluble compound upon reaction with dissolved silicon.

According to several exemplary embodiments, the acidic base fluid includes one or more of HCl, HF, acetic acid, formic acid, citric acid, lactic acid, glycolic acid, sulfamic acid, tartaric acid, methanesulfonic acid, trichloroacetic acid, dichloroacetic acid, chloroacetic acid, fluoroboric acid, fluorophosphoric acid, hexafluorotitanic acid, fluorophosphoric acid and phosphoric acid. According to several exemplary embodiments, suitable acid-generating compounds can also be used in the treatment fluid. Examples of acid-generating compounds include, for example, esters, aliphatic polyesters, orthoesters, poly(ortho esters), poly(lactides), poly(glycolides), poly(s-caprolactones), poly(hydroxybutyrates), poly(anhydrides), and any copolymers thereof. Other suitable acid-generating compounds include, for example, ethylene glycol monoformate, ethylene glycol diformate, diethylene glycol diformate, glyceryl monoformate, glyceryl diformate, glyceryl triformate, triethylene glycol diformate and formate esters of pentaerythritol. It should be noted that some of the above acids and acid-generating compounds are reported to complex dissolved silicon at high pH values. However, complexation of dissolved silicon with these species should be negligible at acidic pH values in the present treatment fluids. According to several exemplary embodiments, the acid or acid-generating compound is present in the treatment fluid in an amount of about 1% to about 50% by volume of the treatment fluid. According to several exemplary embodiments, the treatment fluid contains between about 1% to about 37% of acid by volume of the treatment fluid.

According to several exemplary embodiments, fulvic acid is present in the treatment fluid in an amount of about 1% to about 50% by weight of the treatment fluid. According to several exemplary embodiments, the treatment fluid includes about 1% to about 20% of fulvic acid by weight of the treatment fluid.

The treatment fluids may also include one or more additives, such as gel stabilizers, fluid loss control additives, particulates, additional acids, corrosion inhibitors, catalysts, clay stabilizers, biocides, friction reducers, surfactants, solubilizers, pH adjusting agents, bridging agents, dispersants, flocculants, foamers, gases, defoamers, H₂S scavengers, CO₂ scavengers, oxygen scavengers, scale inhibitors, lubricants, viscosifiers, and weighting agents. One of ordinary skill in the art, with the benefit of this disclosure, will be able to determine the appropriate type and amount of such additives for a particular application. For example, according to several exemplary embodiments, it may be desired to foam a treatment fluid using a gas, such as air, nitrogen, or carbon dioxide.

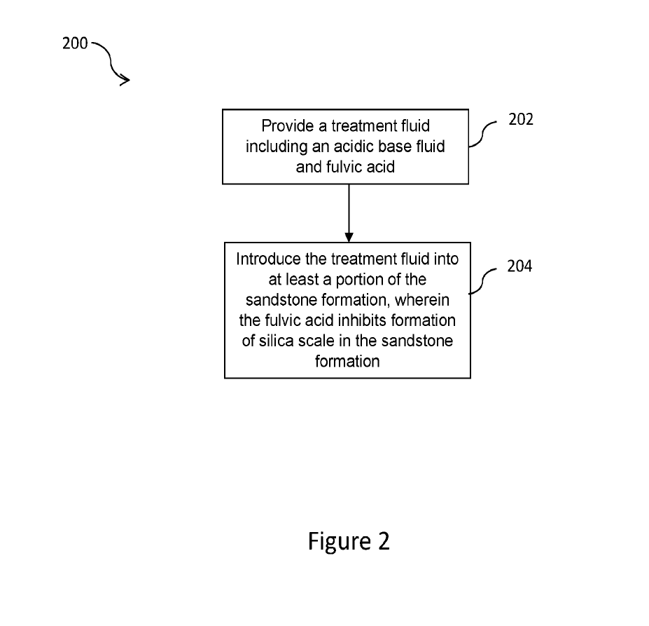

According to several exemplary embodiments, a method of treating a sandstone formation is provided. Turning now to FIG. 2, the method 200 includes providing a treatment fluid including an acidic base fluid and fulvic acid, any salt thereof, or any derivative thereof, or any combination thereof, in step 202, and introducing the treatment fluid into at least a portion of the sandstone formation, wherein the fulvic acid, any salt thereof, or any derivative thereof, or any combination thereof, inhibits formation of silica scale in the sandstone formation in step 204. The term “introducing,” as used herein, includes pumping, injecting, pouring, releasing, displacing, spotting, circulating, or otherwise placing a fluid or material within a well, wellbore, or subterranean formation using any suitable manner known in the art.

According to several exemplary embodiments, the treatment fluids can be used in prevention methods to prevent the formation of precipitates such as, for example, those produced in conjunction with a HF acid treatment in a sandstone formation. According to several exemplary embodiments, the treatment fluids may remove potentially damaging precipitates from the sandstone formation.

According to several exemplary embodiments, the treatment fluids may be allowed to reside in the sandstone formation for a period of time after being introduced thereto. According to several exemplary embodiments, the fulvic acid in the treatment fluids increases an amount of dissolved silicon that is present in the treatment fluids while downhole. According to several exemplary embodiments, the fulvic acid can effectively maintain any dissolved silicon in solution, thereby protecting the sandstone formation from damaging silica scale buildup.

According to several exemplary embodiments, the treatment fluids are removed from the sandstone formation. According to several exemplary embodiments, removal of the treatment fluid can be performed after the dissolved silicon in the treatment fluid has reached a desired level or after a set shut-in period has passed. According to several exemplary embodiments, once the treatment fluid has been removed from the sandstone formation, a fresh batch of treatment fluid can be introduced to the sandstone formation to continue the treatment operation, or another type of treatment operation can be commenced.

According to several exemplary embodiments, the treatment fluids may be used as a pre-treatment to a fracturing treatment, especially in subterranean formations that contain different layers of sedimentary rock. According to several exemplary embodiments, the treatment fluid is placed in a subterranean formation via a wellbore before a fracturing treatment. The subsequent fracturing treatment can be a traditional fracturing treatment or an additional acidizing treatment directed at treating the particulate pack introduced during the fracturing operation. According to several exemplary embodiments, the use of the treatment fluids may be considered a prevention mechanism to prevent the formation of potentially problematic precipitates.

According to several exemplary embodiments, the treatment fluids may be used to clean the wellbore area before bringing the well into final production. Using such a treatment fluid can remove damage, blockages, debris, and natural clays in the formation, for example.

According to several exemplary embodiments, the fulvic acid in the treatment fluid can form a complex with at least a portion of any metal ions present in the sandstone formation. For example, fulvic acid can form a complex with aluminum ions in the presence of dissolved silicon to prevent the formation of aluminum scale. According to several exemplary embodiments, metal ions such as, for example, Ca²⁺ and Mg²⁺ can also be complexed by fulvic acid. All of the aforementioned metal ions are normally present to some degree in sandstone formations.

The following examples are illustrative of the compositions and methods discussed above and are not intended to be limiting.

### Example 1

Silica Scale Inhibition at Room Temperature

Two test fluids were prepared to evaluate the ability of fulvic acid to inhibit the formation of silica scale. To prepare the first test fluid, 12 grams of sodium silicate (Na₂SiO₃.5H₂O) was dissolved in 100 mL of water, and the pH of the first test fluid was adjusted to 1 using a 36.5% HCl solution. The first test fluid was filtered using a 0.2 micron-size Nalgene® filter to remove insoluble materials. To prepare the second test fluid, 12 grams of sodium silicate (Na₂SiO₃.5H₂O) and 1 gram of fulvic acid were dissolved in 100 mL of water, and the pH of the second test fluid was adjusted to 1 using a 36.5% HCl solution. Fulvic acid was added to the water prior to the sodium silicate. The second test fluid was filtered using a 0.2 micron-size Nalgene® filter to remove insoluble materials. These two test fluids were used to observe precipitation with increased pH conditions at room temperature.

The pH of the two test fluids was gradually increased using MO-67™ sodium hydroxide pH control agent, which is available from Halliburton Energy Services, Inc. The results of the tests are tabulated below in Table 1.

TABLE 1
Silica Scale Inhibition at Room Temperature

| Test Fluid 1 | | | Test Fluid 2 | | |
|---|---|---|---|---|---|
| | Time | | | Time | |
| pH | (minutes) | Observation | pH | (minutes) | Observation |
| 2 | 5 | Very thick | 2 | 300 | No |
| | | mass | | | precipitation |
| 3 | 3 | Height of | 3 | 300 | No |
| | | thick mass is | | | precipitation |
| | | increased | | | |
| 4 | 4 | Height of | 4 | 300 | No |
| | | thick mass is | | | precipitation |
| | | further | | | |
| | | increased | | | |
| 5.6 | 2 | Complete | 5.6 | 40 | Precipitation, |
| | | thick gel | | | but in |
| | | formation | | | flowable form |

As can be seen from Table 1, the test fluid with fulvic acid effectively inhibited the formation of silica scale to as high a pH as 4, while the test fluid without fulvic acid exhibited silica scale formation at a pH of 2. Even at a pH of 5.6, where the test fluid without fulvic acid exhibited complete thick gel formation, the precipitate in the test fluid with fulvic acid was flowable.

### Example 2

Silica Scale Inhibition at Higher Temperature

Additional tests using the first and second test fluids of Example 1 were performed to understand the effectiveness of silica scale inhibition at 190° F. As in Example 1, the pH of the two test fluids was gradually increased using MO-67™ pH control agent. The results of the tests are tabulated below in Table 2.

TABLE 2
Silica Scale Inhibition at 190° F.

| Test Fluid 1 | | | Test Fluid 2 | | |
|---|---|---|---|---|---|
| | Time | | | Time | |
| pH | (minutes) | Observation | pH | (minutes) | Observation |
| 2 | 5 | Very thick | 2 | 300 | No |
| | | mass | | | precipitation |
| 3 | 3 | Height of | 3 | 300 | No |
| | | thick mass is | | | precipitation |
| | | increased | | | |
| 5.4 | 4 | Complete | 5.4 | 300 | Precipitation, |
| | | thick gel | | | but in |
| | | formation | | | flowable form |

Even at higher temperatures, the test fluid with fulvic acid inhibited the formation of silica scale up to a pH of 3, while the test fluid without fulvic acid exhibited silica scale formation at a pH of 2. Even at a pH of 5.4, where the test fluid without fulvic acid exhibited complete thick gel formation, the precipitate in the test fluid with fulvic acid was flowable.

### Example 3

Aluminum Scale Inhibition in the Presence of Dissolved Silicon

Two test fluids were prepared to evaluate the ability of fulvic acid to chelate aluminum in the presence of dissolved silicon, to replicate conditions downhole. To prepare the first test fluid, 3 grams of sodium silicate (Na₂SiO₃.5H₂O) was dissolved in 100 mL of water, and the pH of the solution was adjusted to 1 using a 36.5% HCl solution. The resulting solution was filtered using a 0.2 micron-size Nalgene® filter to remove insoluble materials. One (1) gram of aluminum chloride (AlCl₃) was then added to the solution to form the first test fluid. To prepare the second test fluid, 3 grams of sodium silicate (Na₂SiO₃.5H₂O) and 1 gram of fulvic acid were dissolved in 100 mL of water, and the pH of the solution was adjusted to 1 using a 36.5% HCl solution. Fulvic acid was added to the water prior to the sodium silicate. The resulting solution was filtered using a 0.2 micron-size Nalgene® filter to remove insoluble materials. One (1) gram of aluminum chloride (AlCl₃) was then added to form the second test fluid. These two test fluids were used to observe precipitation of aluminum scale with increased pH conditions.

The pH of the two test fluids was gradually increased using MO-67™ pH control agent. The results of the tests are tabulated below in Table 3.

TABLE 3
Aluminum Scale Inhibition in the Presence of Dissolved Silicon

| Test Fluid 1 | | | Test Fluid 2 | | |
|---|---|---|---|---|---|
| | Time | | | Time | |
| pH | (minutes) | Observation | pH | (minutes) | Observation |
| 1 | 60 | No | 1 | 60 | No |
| | | precipitation | | | precipitation |
| 2 | 10 | Precipitation | 2 | 200 | No |
| | | | | | precipitation |
| 3 | 10 | Thick mass | 3 | 200 | No |
| | | | | | precipitation |
| 4 | 8 | Full thick | 4 | 40 | Very small |
| | | mass | | | amount of |
| | | | | | scale |

The test fluid with fulvic acid effectively inhibited the formation of aluminum scale up to a pH of 3. In contrast, aluminum scale was observed in the test fluid without fulvic acid at a pH of 2, 3, and 4. Even at a pH of 4, just a very small of aluminum scale was observed in the test fluid with fulvic acid.

### Example 4

Ability of Fulvic Acid to Chelate Aluminum, Calcium, and Magnesium and Form a Soluble Complex with Silica in the Presence of HF

Four samples were prepared in a beaker as shown in Table 4.

TABLE 4
Compositions of Test Samples

| | | | | | | Impurities | |
|---|---|---|---|---|---|---|---|
| | | | | | | filtered | |
| | | | | Ammonium | | with | Final |
| | MGDA | Fulvic | HCl (32 Be) | Bifluoride | Water | Nalgene | Solution |
| Sample | (mL) | Acid (g) | (mL) | (g) | (mL) | Filter | (mL) |
| #1 | 31 | 0 | 38.5 | 2.4 | 55.7 | No | 100 |
| #2 | 31 | 0 | 14.8 | 1.5 | 54.2 | No | 100 |
| #3 | 0 | 6.25 | 4.6 | 1.5 | 95 | Yes | 58 |
| #4 | 0 | 0 | 38.5 | 2.4 | 55.7 | No | 100 |

After filtration of Sample #3, 58 mL of filtrate was collected. The prepared samples were pre-heated to 180° F. before addition of bentonite clay and SSA-1™ sand. Once the clay and sand were added to each sample, heating was continued for another 15-20 minutes, and the contents were then filtered using Whatman® filter paper, grade 4. The initial weight measurements and resulting weight measurements after filtration are provided in Table 5 below.

TABLE 5
Weight Measurements Before and After Filtration (Whatman ® filter paper, grade 4)

| | | | | | | Beaker + | |
|---|---|---|---|---|---|---|---|
| | | | | | | Filter | |
| | | | | | Initial | Paper + | Difference |
| | Filter | | Clay and | Beaker | Weight | Filter | in Weight |
| Sample | Paper (g) | Sand (g) | Sand (g) | (g) | (g) | Cake (g) | (g) |
| #1 | 1.3158 | 2.1 | 7.3985 | 44.2453 | 52.9596 | 53.0251 | −0.0655 |
| #2 | 1.3211 | 2.08 | 7 | 44.2144 | 52.5355 | 53.795 | −1.2595 |
| #3 | 1.331 | 1.175 | 4.195 | 44.2139 | 49.7399 | 49.7492 | −0.0093 |
| #4 | 1.3063 | 2.46 | 7.11 | 44.1748 | 53.1911 | 49.1758 | 4.0153 |

In Table 5, the difference in weights for Sample #2 and Sample #3 indicate that MGDA caused more precipitation compared to fulvic acid in static condition. The reason for precipitation could be use of filter paper that is not able to separate chelate complexes from the sand and clay. Therefore, additional tests were performed using a Nalgene filter.

The compositions of Table 4 were prepared again and the process repeated using a Nalgene filter instead of Whatman® filter paper, grade 4. Table 6 shows the initial weight measurements and resulting weight measurements after filtration.

TABLE 6
Weight Measurements Before and After Filtration (Nalgene Filter)

| | | | | MGDA | | | | | |
|---|---|---|---|---|---|---|---|---|---|
| | | Clay | | or | | | | | |
| | Nalgene | and | | Fulvic | Initial | Nalgene | | Final | Difference |
| | Filter | Sand | Beaker | Acid | Weight | Filter | Beaker | Weight | in Weight |
| Sample | (g) | (g) | (g) | (g) | (g) | (g) | (g) | (g) | (g) |
| #2 | 50.5673 | 7.719 | 44.2205 | 5 | 107.5068 | 55.4916 | 45.9065 | 101.3981 | 6.1087 |
| #3 | 50.5783 | 7.7637 | 44.1939 | 6 | 108.5359 | 57.53 | 44.3845 | 101.9145 | 6.6214 |
| #4 | 50.543 | 7.71 | 44.1748 | 0 | 102.4278 | 52.7745 | 47.6125 | 100.387 | 2.0408 |

For Sample #4, there was a considerable amount of filtercake formed on the Nalgene filter. For Sample #2, less filtercake was formed on the Nalgene filter. For Sample #3, no precipitation or even slight precipitation was visually observed.

Based on the tests performed, fulvic acid is able to chelate ions one or more ions including Al⁺³, Ca⁺², and Mg⁺² in the presence of HF. Fulvic acid is also able to form a soluble complex with silica (e.g., Si⁴⁺) in the presence of HF.

Although only a few exemplary embodiments have been described in detail above, those of ordinary skill in the art will readily appreciate that many other modifications are possible in the exemplary embodiments without materially departing from the novel teachings and advantages of the present invention. Accordingly, all such modifications are intended to be included within the scope of the present invention as defined in the following claims.

What is claimed is:

1. A method of treating a sandstone formation comprising:
providing a treatment fluid including an acidic base fluid and fulvic acid, any salt thereof, any derivative thereof, or any combination thereof; and
introducing the treatment fluid into at least a portion of the sandstone formation, wherein the fulvic acid, any salt thereof, any derivative thereof, or any combination thereof, inhibits formation of silica scale in the sandstone formation.

2. The method of claim 1, wherein the acidic base fluid comprises an aqueous-based fluid.

3. The method of claim 1, wherein the acidic base fluid comprises one or more acids selected from the group consisting of hydrofluoric acid, hydrochloric acid, and acetic acid.

4. The method of claim 3, wherein the one or more acids is present in the treatment fluid in an amount of about 1 percent to about 30 percent by volume of the treatment fluid.

5. The method of claim 1, wherein the fulvic acid, any salt thereof, any derivative thereof, or any combination thereof, is present in the treatment fluid in an amount of about 0.01 percent to about 20 percent by weight of the treatment fluid.

6. The method of claim 1, further comprising complexing at least a portion of any metal ions present in the sandstone formation with the fulvic acid, any salt thereof, any derivative thereof, or any combination thereof.

7. The method of claim 6, wherein the metal ions comprise one or more of, aluminum, calcium, and magnesium.

8. The method of claim 1, wherein the treatment fluid has a pH of about 1 to about 3.

9. The method of claim 1, wherein a pump is used to introduce the treatment fluid into at least a portion of the sandstone formation.

10. The method of claim 1, further comprising:
after introducing the treatment fluid, allowing the treatment fluid to reside in the sandstone formation for a period of time, and
removing the treatment fluid from the sandstone formation.

11. A method of treating a sandstone formation comprising:
providing a treatment fluid including an aqueous fluid, hydrofluoric acid, hydrochloric acid, and fulvic acid, any salt thereof, any derivative thereof, or any combination thereof, and
introducing the treatment fluid into at least a portion of the sandstone formation, wherein the fulvic acid, any salt thereof, any derivative thereof, or any combination thereof, inhibits formation of silica scale in the sandstone formation.

12. The method of claim 11, wherein the hydrofluoric acid and hydrochloric acid is present in the treatment fluid in an amount of about 0.01 percent to about 30 percent by volume of the treatment fluid.

13. The method of claim 11, wherein the fulvic acid, any salt thereof, any derivative thereof, or any combination thereof, is present in the treatment fluid in an amount of about 0.01 percent to about 20 percent by weight of the treatment fluid.

14. The method of claim 11, further comprising complexing at least a portion of any metal ions present in the sandstone formation with the fulvic acid, any salt thereof, any derivative thereof, or any combination thereof.

15. The method of claim 14, wherein the metal ions comprise one or more of, aluminum, calcium, and magnesium.

16. The method of claim 11, further comprising:
after introducing the treatment fluid, allowing the treatment fluid to reside in the sandstone formation for a period of time; and
removing the treatment fluid from the sandstone formation.

17. A treatment fluid for acidizing a sandstone formation comprising:
an aqueous fluid;
hydrofluoric acid;
hydrochloric acid; and
fulvic acid, any salt thereof, any derivative thereof, or any combination thereof in an amount sufficient to inhibit formation of silica scale in the sandstone formation.

18. The treatment fluid of claim 17, having a pH of about 1 to about 3.

19. The treatment fluid of claim 17, wherein the hydrofluoric acid and hydrochloric acid is present in the treatment fluid in an amount of about 0.01 percent to about 30 percent by volume of the treatment fluid.

20. The treatment fluid of claim 17, wherein the fulvic acid, any salt thereof, any derivative thereof, or any combination thereof, is present in the treatment fluid in an amount of about 0.01 percent to about 20 percent by weight of the treatment fluid.
